(19) United States
(12) Patent Application Publication
(10) Pub. No.: US 2009/0153020 A1
(43) Pub. Date: Jun. 18, 2009

(54) IMAGE DISPLAY APPARATUS

(75) Inventors: Kanako Ito, Fujisawa-shi (JP); Takashi Enomoto, Sagamihara-shi (JP); Reiwo Mochida, Hiratsuka-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/276,548

(22) Filed: Nov. 24, 2008

(30) Foreign Application Priority Data
Dec. 14, 2007 (JP) 2007-322748

(51) Int. Cl. H01J 63/04

(52) U.S. Cl. 313/495

(57) ABSTRACT

In the image display apparatus using the electron-emitting device, wiring metal is prevented from being diffused to a fine particle when a fine particle dispersed film is disposed on the wiring, and the image characteristic is prevented from being degraded because of the diffusion. A first wiring 4 and a second wiring 6 intersecting with the first wiring 4 through an insulating layer are formed on an insulation substrate 1, and after an electroconductive shielding layer 7 is formed on the second wiring 6, a anti static film made of a fine particle dispersed film is formed.

### BACKGROUND OF THE INVENTION

1. Field of the Invention

The present invention relates to an image display apparatus using an electron-emitting device as an electron source, and particularly, to the diffusion prevention of metal used for a wiring of the image display apparatus.

2. Description of the Related Art

In recent years, two types of the electron-emitting device are known, that is, a thermal electron source and a cold cathode electron source, and the cold cathode electron source includes an electron emission type-device, metal/insulating layer/metal type-device, a surface conduction electron-emitting device, or the like. There is a known display apparatus in which the surface conduction electron-emitting device is used among the cold cathode electron sources.

Such an apparatus, even with a large screen, can be relatively easily constructed by combining a rear plate having a large number of the surface conduction electron-emitting devices arranged as the electron source with a face plate including phosphor emitting visible light. Electrons emitted from the electron-emitting device are accelerated and caused to enter an image forming member made of the phosphor to obtain the brightness. In the image display apparatus, it is necessary to electrically isolate the electron-emitting devices from each other since they respond to an input signal, and therefore an insulating substrate is generally used. However, when a surface of the insulating substrate is exposed near an electron-emitting site, electric potential of the surface becomes unstable, and the electron emission becomes unstable.

When high voltage is applied to the phosphor of an image forming member, electric potential is induced on an insulation surface around the opposing electron-emitting device due to capacitive division, which is determined by dielectric constants of a vacuum and an insulator. The better the insulation is, the longer the time constant this electric potential would have, and the surface would remain charged. When the electrons are emitted from the electron-emitting device in such a condition, the electrons also collide with the charged insulation surface. In this case, the accelerated electrons cause charged particle such as electrons and ions to be injected into the insulation surface to induce secondary electrons. Particularly under high electric field, the resultant abnormal discharge significantly degrades electron emission characteristics of the device, resulting in damage to the device in the worst case. As a countermeasure for such abnormal discharge thus induced, Japanese Patent Application Laid-Open No. 2006-127794 (U.S. Patent Publication No. 2006/0087219) discloses such a technique that a part of the electron-emitting device excluding an electron-emitting site is covered by an insulating layer so that discharge current is not flown in the electron-emitting device.

As another countermeasure, Japanese Patent Application Laid-Open No. 2002-358874 discloses a method for providing an anti static film around the electron-emitting device by splaying solution obtained by dispersing an electroconductive fine particle in organic solvent.

It is necessary that the above anti static film is connected to a power source to cause the charge to escape. Such a configuration is generally adopted that ensures electrical connection between the anti static film and the power source by bringing electroconductive material, such as the wiring, connected to the power source into contact with the anti static film. However, it is considered that, when a fine particle dispersed film containing SnOₓ is used as the anti static film, the metal used in the wiring is, because of a thermal process, diffused to the fine particle of the anti static film, and a metal crystal substance separates out and grows on a fine particle surface. When this metal is heated in the vacuum, and voltage is applied thereto, such a problem may arise that electrons are emitted from the metal crystal substance, and desired image characteristics can not be obtained.

### SUMMARY OF THE INVENTION

An object of the present invention is to prevent wiring metal from being diffused to a fine particle when a fine particle dispersed film is disposed on a wiring, and to prevent image characteristics from being degraded because of the diffusion, in an image display apparatus using an electron-emitting device.

The image display apparatus of the present invention includes a first substrate including, at least, a first wiring, a second wiring intersecting with the first wiring through an insulating layer, and an electron-emitting device provided with a pair of device electrodes connected to the first wiring and the second wiring respectively, and a second substrate, which is disposed facing the first substrate, including, at least, an electrode whose electronic potential is defined higher than that of the second wiring, and an image forming member which emits light while irradiated by the electron emitted from the above electron-emitting device, and the image display apparatus of the present invention further includes a fine particle dispersed film, which is electrically connected to the second wiring, on the first substrate, and includes an electroconductive shielding layer for shielding the second wiring from the fine particle dispersed film between the second wiring and the fine particle dispersed film.

According to the present invention, the wiring metal is prevented from being diffused to the fine particle of the anti static film even when subjected to the thermal process. Thus, it is possible to prevent the image characteristics from being degraded because of the diffusion, and to provide the highly-reliable image display apparatus.

Further features of the present invention will become apparent from the following description of exemplary embodiments with reference to the attached drawings.

### BRIEF DESCRIPTION OF THE DRAWINGS

FIG. 1A is a schematic view illustrating in order the steps for producing a first substrate according to an exemplary embodiment of an image display apparatus of the present invention.

FIG. 1B is a schematic view illustrating in order the steps for producing the first substrate according to the exemplary embodiment of the image display apparatus of the present invention.

FIG. 1C is a schematic view illustrating in order the steps for producing the first substrate according to the exemplary embodiment of the image display apparatus of the present invention.

FIG. 1D is a schematic view illustrating in order the steps for producing the first substrate according to the exemplary embodiment of the image display apparatus of the present invention.

FIG. 1E is a schematic view illustrating in order the steps for producing the first substrate according to the exemplary embodiment of the image display apparatus of the present invention.

FIG. 1F is a schematic view illustrating in order the steps for producing the first substrate according to the exemplary embodiment of the image display apparatus of the present invention.

FIG. 1G is a schematic plain view of the first substrate according to the exemplary embodiment of the image display apparatus of the present invention.

FIG. 1H is a partially enlarger sectional view along a line 1H-1H in FIG. 1G.

FIG. 2A is a schematic view illustrating a configuration of an electron-emitting device used for the first substrate in FIGS. 1A, 1B, 1C, 1D, 1E, 1F, 1G and 1H.

FIG. 2B is a cross-section 2B-2B in FIG. 2A.

FIG. 3 is a schematic view illustrating an example of a display panel of the image display apparatus constructed by using the first substrate in FIGS. 1A, 1B, 1C, 1D, 1E, 1F, 1G and 1H.

### DESCRIPTION OF THE EMBODIMENTS

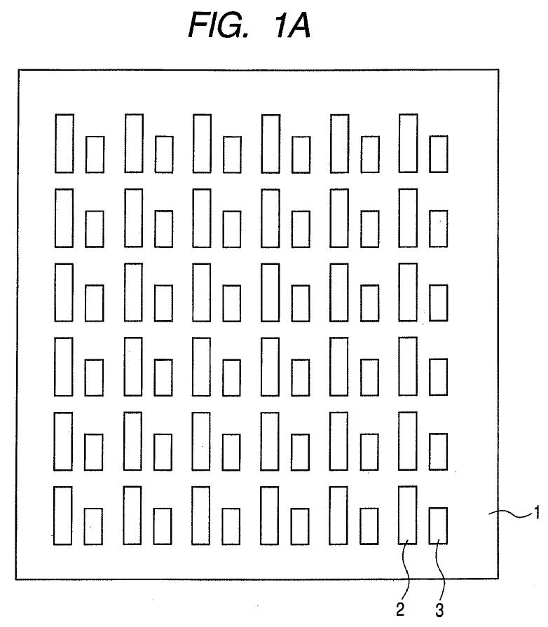

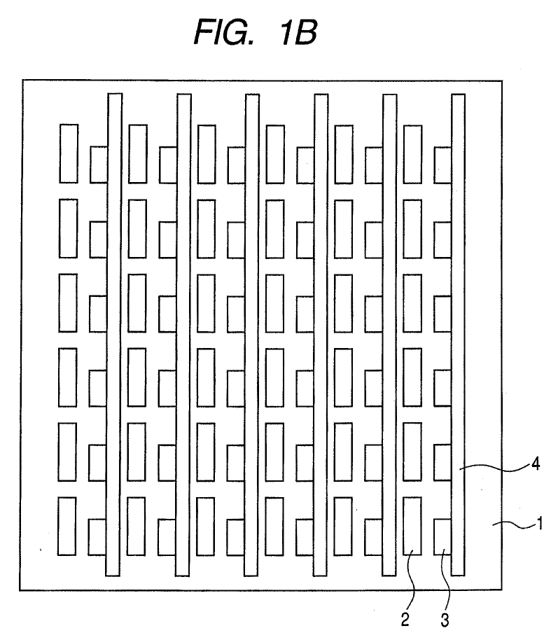

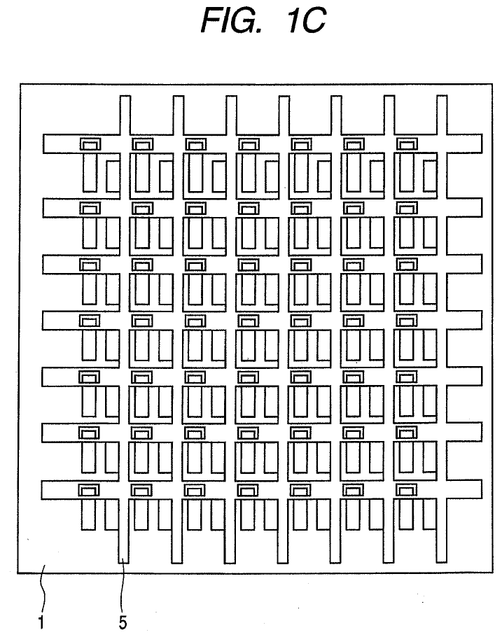

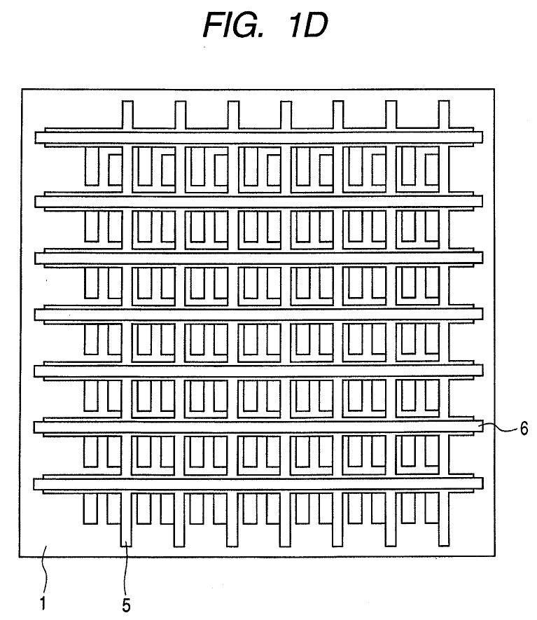

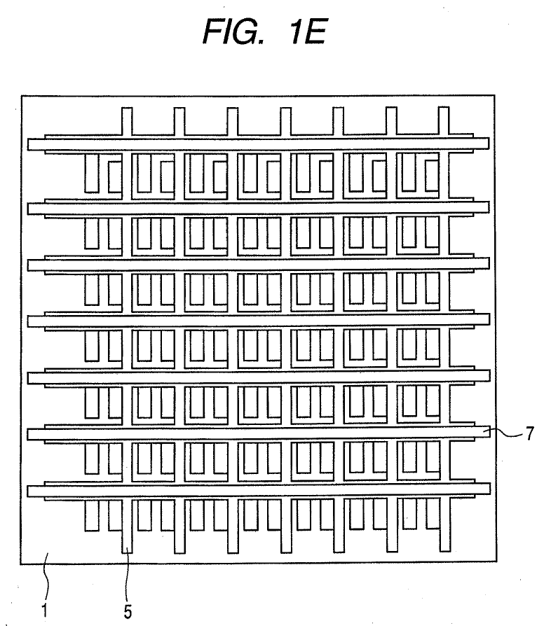

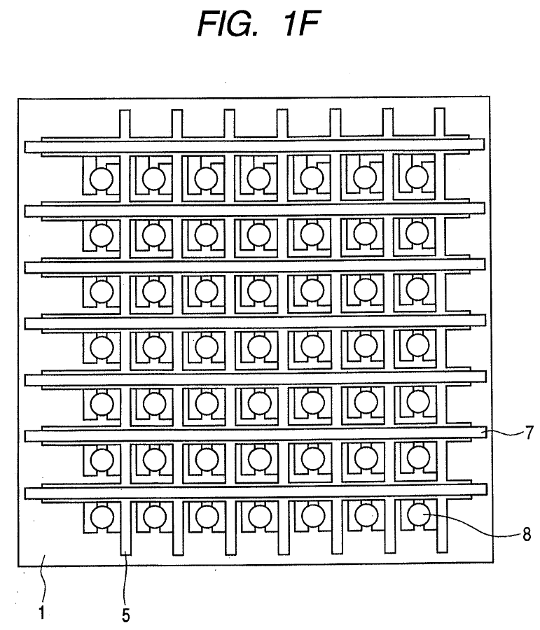

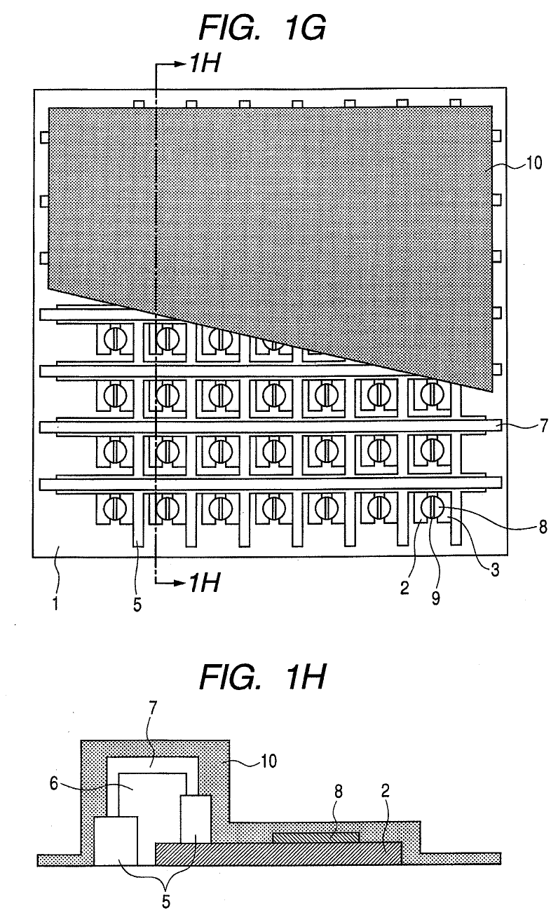

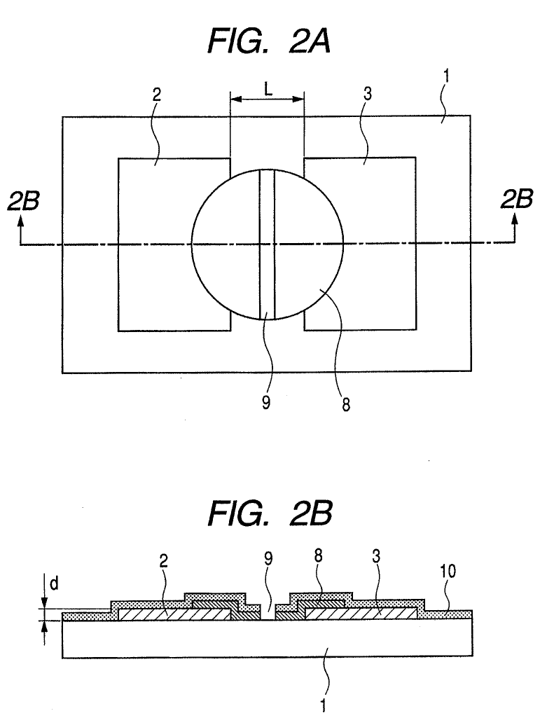

FIG. 2A illustrates an exemplary configuration of a surface conduction electron-emitting device preferably used for the present invention, and FIG. 1G illustrates an exemplary configuration of a first substrate, in which the electron-emitting device in FIG. 2A is used, of the image display apparatus of the present invention. FIGS. 1A, 1B, 1C, 1D, 1E and 1F are views illustrating producing steps for the first substrate in FIG. 1G. In the figures, Reference numeral 1 denotes a substrate, Reference numerals 2 and 3 denote device electrodes, Reference numeral 4 denotes a first wiring, Reference numeral 5 denotes an insulating layer, Reference numeral 6 denotes a second wiring, Reference numeral 7 denotes a shielding layer, Reference numeral 8 denotes an electroconductive film, Reference numeral 9 denotes an electron-emitting site formed in the electroconductive film 8, and Reference numeral 10 denotes an anti static film. Meanwhile, FIG. 2B is a cross-section 2B-2B in FIG. 2A, and for the convenience of the description, the anti static film 10 is omitted in FIG. 2A. Even in FIG. 1G, for the convenience of the description, the anti static film 10 is illustrated with a part omitted.

A configuration of the first substrate according to the present invention will be described below by using, as an example, the steps for producing the first substrate in FIGS. 1A, 1B, 1C, 1D, 1E, 1F, 1G and 1H.

A pair of the device electrodes 2 and 3 are formed with metal material at each intersecting point of the after-mentioned first wiring 4 and the second wiring 6 on the cleaned substrate 1 (FIG. 1A).

The following substrates can be used as the substrate 1: a glass substrate obtain by stacking SiO₂ formed, by the spattering method, on silica glass, glass in which a contained amount of impurity such as Na is reduced, and soda lime glass; and a ceramics substrate such as alumina and a Si substrate.

The device electrodes 2 and 3 are formed by a method for forming a metal thin film by using a vacuum-based film-forming method such as a vacuum-evaporating method, a spattering method and a plasma CVD method, and patterning by the photolithography method to etch the metal thin film. In addition, a method is also used, in which the metal organic paste containing organic metal is offset-printed by using the glass intaglio printing, and the method can be arbitrarily selected.

In the device electrodes 2 and 3, for example, electrode distance L (refer to FIG. 2A) is caused to be several dozen to several hundreds μm, and film thickness d is caused to be several dozen to several hundreds nm. It is enough that material of the device electrodes is electroconductive material. For example, the material includes a print conductor including metal such as Ni, Cr, Au, Mo, W, Pt, Ti, Al, Cu and Pd or alloy of such metal, metal such as Pd, Ag, Au, RuO₂ and Pd—Ag or oxide of such metal, and glass. The material also includes semiconductor material such as polysilicon, and a transparent conductor such as In₂O₃—SnO₂.

Next, the first wiring 4 in the form of a matrix wiring is formed by using electroconductive paste (FIG. 1B). As the forming method, the first wiring 4 can be formed by a screen printing method or the photolithography method. In this case, the first wiring 4 is formed so as to be connected to the device electrode 3. It is preferable in this first wiring 4 that film thickness is formed thicker to reduce electric resistance, and metal such as Ag, Au, Cu, Ni, Pt and Pd, or alloy of such metals is used as the electroconductive paste.

Next, in the matrix wiring, the insulating layer 5 is formed by using glass paste, which isolates the first wiring 4 from the later-formed second wiring 6 (FIG. 1C). Meanwhile, as illustrated in FIG. 1C, it is better that the insulating layer 5 is formed not only on the first wiring 4, but also in a part in which the second wiring 6 is formed, and thereby, it is preferable that the second wiring 6 can be also securely isolated from the device electrode 3. As a method for forming the insulating layer 5, the screen printing method or the photolithography method can be selected. The glass paste used for the insulating layer 5 includes frit glass, whose main component is lead oxide or bismuth oxide, mixed with appropriate polymer such as cellulose, organic solvent and a vehicle.

Next, the second wiring 6, which is in the form of the matrix wiring as intersecting with the first wiring 4, is formed on the insulating layer 5 by using the electroconductive paste (FIG. 1D). As the method for forming the second wiring 6, the screen printing method or the photolithography method can be selected. As the electroconductive paste, it is preferable that metal such as Ag, Au, Cu, Ni, Pt and Pd, or alloy of such metals is, for example, used to reduce the electric resistance in a similar way to the first wiring 4.

Next, the shielding layer 7 is formed on the second wiring 6 (FIG. 1E). As the method for forming the shielding layer 7, the screen printing method, the photolithography method or an ink-jet method can be selected.

In this case, it is necessary to form the shielding layer 7 so that the second wiring 6 is not exposed, so that it is preferable to cover at least 80% or more of a surface of the second wiring 6, which faces an after-mentioned second substrate.

To secure electrical connection between the second wiring 6 and the later-formed anti static film made of the fine particle dispersed film, the shielding layer 7 needs to satisfy an electric potential rule for a spacer, so that the shielding layer 7 is electroconductive. The following material can be, for example, selected as material of the shielding layer 7: metal such as Pt, Ru, Ag, Au, Ti, In, Cu, Ni, Cr, Fe, Zn, Sn, Ta, W and Pd; and glass paste or a fine particle film including oxide such as PdO, SnO₂, In₂O₃, PbO and Sb₂O₃. Particularly, to satisfy the adherence with the insulating layer 5 and the electric potential rule, it is preferable to select metal fine particle paste whose main component is Ni, and which include a small amount of glass powder.

It is enough that the shielding layer 7 is thick to the extent that metal can be prevented from being diffused from the second wiring 6 in a baking step, and the thickness is not particularly restricted, however, from a viewpoint of the thickness when a panel is formed, the thickness is generally 0.2 μm to 10 μm, preferably 1 μm or more, and 1 μm to 5 μm.

Next, the electroconductive film 8 is formed through a pair of the device electrodes 2 and 3 (FIG. 1F). A specific example of a material includes metal such as Pt, Ru, Ag, Au, Ti, In, Cu, Cr, Fe, Zn, Sn, Ta, W and Pd, and oxide such as PdO, SnO₂, In₂O₃, PbO and Sb₂O₃. In addition, the specific example includes boride such as HfB₂, ZrB₂, LaB₆, CeB₆, YB₄ and CdB₄, carbide such as TiC, ZrC, HfC, TaC, SiC and WC, and nitride such as TiN, ZrN and HfN. Further, the specific example includes semiconductor of Si and Ge, carbon, Ag, Mg, NiCu, Pb and Sn. Such electroconductive film 8 is made of a fine particle film. Meanwhile, the fine particle film described here means a film obtained by assembling a plurality of fine particles, and a microstructure of the fine particle film includes not only such a condition that the fine particles are arranged as being individually dispersed, but also such a condition that the fine particles are adjacent to each other, or are overlapped by each other (including island-like condition). The inkjet method is preferably used for forming the electroconductive film 8. A principle and a configuration of the inkjet method are very simple, and this is because the inkjet method includes many advantages such as it is easy to speed-up and to reduce a size of a droplet. Actually, after solution of organic metal compound including the above electroconductive material is provided as the droplet only at a predetermined position to be dried, since the organic metal compound is thermally decomposed by the thermal process, the electroconductive film 8 is formed, which is made of metal or metal oxide.

Next, the anti static film 10 for preventing the charge on a surface of the substrate 1 is formed on the substrate 1 (on the first substrate). It is preferable that the anti static film 10 includes a sheet resistance value of approximately 10¹⁰ Ohms per square to 10¹² Ohms per square to prevent the charge from being discharged. When the electron source is constructed, it is requested from a permissible value for leak current between the first wiring 4 and the second wiring 6 that the sheet resistance value is 10⁸ Ohms per square or more. The anti static film 10 is the fine particle dispersed film obtained by spray-applying the organic solution, in which the electroconductive fine particle is dispersed, and dry-eliminating the spray-applied organic solution. As the electroconductive fine particle, the fine particle, whose main component is carbon material, SnOₓ or chrome oxide, is preferably used, and SnOₓ, in which antimony is doped, is the more preferable main component. As the organic solution, alcohol-type solution is preferably used, and for example, mixed solution of isopropyl alcohol (IPA) and ethyl alcohol is preferably used.

Next, the electroconductive film 8 is electro-energized, and the electron-emitting site 9 is formed (FIG. 1G). Meanwhile, FIG. 1G illustrates the anti static film 10 with a part omitted to describe the electron-emitting site 9. And, FIG. 1H shows a partially enlarged sectional view along a line 1H-1H in FIG. 1G. The electron-emitting site 9 is a high-resistance gap formed in a part of the electroconductive film 8 (FIG. 2A), and depends on film thickness, film quality, material and an electro energization condition of the electroconductive film 8. The electroconductive fine particle may be included in the gap of the electron-emitting site 9, whose particle size is in a range of several hundreds pm to several dozen nm. This electroconductive fine particle includes a part or all of elements of material included in the electroconductive film 8. Carbon and carbon compound may be included in the electron-emitting site 9 including the gap and the electroconductive film 8 near the electron-emitting site 9.

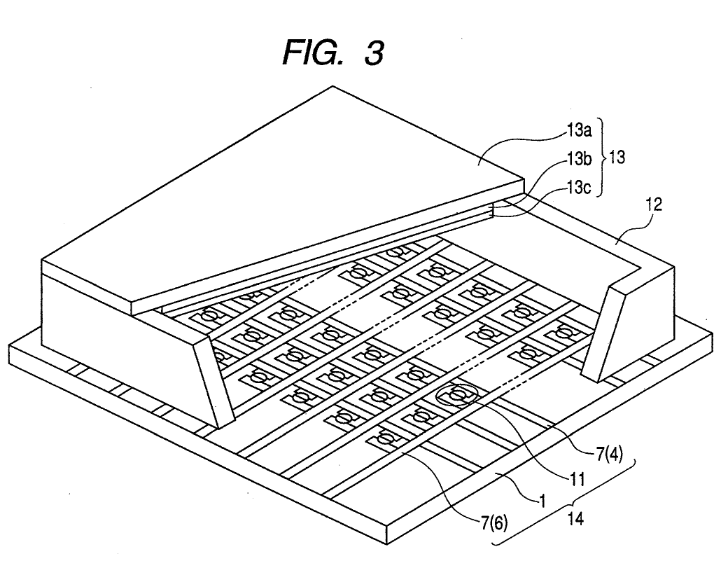

The image display apparatus of the present invention will be described by using FIG. 3, which is constructed with the electron source in which a plurality of such electron-emitting devices are matrix-arranged. FIG. 3 is a schematic view illustrating en example of a display panel of a preferable exemplary embodiment of the image display apparatus of the present invention. In FIG. 3, Reference numeral 11 denotes an electron-emitting device, Reference numeral 12 denotes a supporting frame, Reference numeral 13 denotes a face plate (second substrate), Reference numeral 13a denotes a substrate, Reference numeral 13b denotes a fluorescent film (image forming member), Reference numeral 13c denotes an anode electrode (metal back), Reference numeral 14 denotes a rear plate (first substrate).

The rear plate 14 is an electron source substrate in which a plurality of the electron-emitting devices 11 are matrix-arranged. The face plate 13 is made up of the fluorescent film 13b including a light-emitting substance such as the phosphor and the metal back 13c as the anode electrode, which are formed inside the substrate 13a. The metal back 13c is defined to be at the higher electronic potential than the second wiring 6, and since the electron emitted from the electron-emitting device 11 is irradiated to the fluorescent film 13b, the fluorescent film 13b emits light. Reference numeral 12 is the supporting frame, and the rear plate 14 and the face plate 13 are seal-bonded by using the frit glass. In this seal-bonding, for example, to vacuumize the inside of the image display apparatus, the inside of the image display apparatus is baked in the vacuum to be seal-bonded. On the other hand, a support (not-illustrated) referred to as a spacer can alternatively be provided between the face plate 13 and the rear plate 14, so that the image display apparatus can be adapted to have sufficient strength for the atmospheric pressure.

In the image display apparatus of the present invention, even when the fine particle dispersed film including SnOₓ is provided as the anti static film 10 on a surface of the rear plate 14, the shielding layer 7 on the second wiring 6 prevents the metal of the second wiring 6 from being diffused to the above fine particle. Thus, a metal granularity substance and a metal single crystal do not separate out and grow in the anti static film 10 even through a vacuum baking process for the seal-bonding, and the abnormal discharge can be prevented when the voltage is applied in the electron emission.

### Embodiments

### Exemplary Embodiment 1

By using a high-softening point glass substrate used for a plasma display, Pt with film thickness of approximately 20 nm is patterned by a photolithoetching method, and a plurality of pairs of the device electrodes are formed as illustrated in FIG. 1A.

Next, whole surface film forming is executed by the screen printing by using Ag-based photo paste, and the formed film is dried at approximately 100° C. for approximately 15 minutes. The dried film is patterned by using the photolithography method, and a useless part is eliminated. Further, the film is baked at 500° C. for approximately 15 minutes, and the first wiring with film thickness of approximately 8 μm is formed as illustrated in FIG. 1B.

Next, the whole surface film forming is executed by the screen printing by using Bi-based photosensitive glass paste, the formed film is dried at approximately 150° C. for approximately 10 minutes, the dried film is patterned by using the photolithography method, and a useless part is eliminated. Further, the film is baked at 500° C., and the insulating layer is formed as illustrated in FIG. 1C. In the present example, to improve the reliability of the insulation, a plurality of the same insulating layers are stacked, and the insulating layer with layer thickness of approximately 30 μm is formed.

Next, the Ag-based paste is film-formed by the screen printing, is dried at approximately 100° C. for approximately 15 minutes, and is baked at approximately 400° C. for approximately 15 minutes, thereby, the second wiring is formed as illustrated in FIG. 1D. In the present example, to satisfy the resistance value, a plurality of the same wiring layers are stacked, and the second wiring layer with layer thickness of approximately 30 μm is formed.

On the above second wiring, the glass paste, whose main component is indium oxide as the electroconductive material, and which includes a small amount of stannum oxide, is film-formed by the screen printing, is dried at approximately 100° C. for approximately 15 minutes, and is baked at approximately 400° C. for approximately 15 minutes, thereby, the shielding layer with layer thickness of approximately 3 μm is formed as illustrated in FIG. 1E. The ratio of the indium oxide and glass powder used in this case is indium oxide/glass paste=0.67 mass %. The ratio of a part covered by the shielding layer of the second wiring is approximately 80%.

Next, since the Pd-based organic solution is output by the inkjet method, a pattern with film thickness of approximately 5 nm is formed, so that each pair of the device electrodes communicates with each other, thereby, the electroconductive film made of Pd is formed as illustrated FIG. 1F.

Next, the solution, in which the fine particle made of antimony oxide is dispersed in the mixed solution of the IPA and the ethyl alcohol, is splay-applied on the substrate, thereby, the anti static film is formed.

The electroconductive film is electro-energized, and the electron-emitting site is formed as illustrated in FIG. 1G to be the electron-emitting device.

The rear plate formed as described above is opposed to the face plate provided with the fluorescent film and the metal back, and then vacuum-sealed along with the supporting frame to form a panel, in which the existence of the abnormal discharge is checked. As a result of the check, the abnormal discharge due to the diffusion and the separation of Ag used for the second wiring has not been observed. EPMA analysis performed on the interface of Ag and the glass paste, which are samples, has not shown Ag diffused in the part of the glass paste layer at and above 1 μm from an Ag surface. Meanwhile, even when the first wiring and the second wiring are formed with Cu, the diffusion of Cu has not been observed.

### Exemplary Embodiment 2

The rear plate is produced in a similar way to the exemplary embodiment 1 excluding that the shielding layer is formed by using the glass paste including an antimony oxide particle and the stannum oxide as covering approximately 100% of the second wiring.

The rear plate thus formed is used and vacuum-sealed with the face plate, in a similar way to the exemplary embodiment 1, and when the existence of the abnormal discharge is checked, the abnormal discharge due to the diffusion and the separation of Ag used for the second wiring has not been observed. EPMA analysis performed on the interface of Ag and the glass paste, which are samples, has not shown Ag diffused in the part of the glass paste layer at and above 1 μm from an Ag surface. Meanwhile, even when the first wiring and the second wiring are formed with Cu, the diffusion of Cu has not been observed.

### Exemplary Embodiment 3

The rear plate is produced in a similar way to the exemplary embodiment 1 excluding that the shielding layer is formed by using the metal fine particle paste, whose main component is nickel, and which includes a small amount of glass powder, as covering approximately 80% of the second wiring.

The rear plate thus formed is used and vacuum-sealed with the face plate, in a similar way to the exemplary embodiment 1, and when the existence of the abnormal discharge is checked, the abnormal discharge due to the diffusion and the separation of Ag used for the second wiring has not been observed. The abnormal discharge is not checked, which is induced because of the diffusion and the separation of Ag used for the second wiring. Cross-section TEM observation and EDX analysis performed on the interface of Ag and the glass paste, which are samples, have not shown Ag diffused in the part of the metal nickel layer at and above 1 μm from an Ag surface. Meanwhile, even when the first wiring and the second wiring are formed with Cu, the diffusion of Cu has not been observed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-322748, filed Dec. 14, 2007, which is hereby incorporated by reference herein in its entirety.

What is claimed is:

1. An image display apparatus comprising:
a first substrate having at least a first wiring, a second wiring crossing the first wiring through an insulating layer interposed between the first and second wirings, and an electron-emitting device having a pair of device electrodes connected respectively to the first and second wirings; and
a second substrate being placed in opposition to the first substrate, and having an electrode set at a potential higher than a potential of the second wiring, and an image forming member emitting light in response to an irradiation with an electron emitted from the electron-emitting device, wherein
the image display apparatus further comprises
a fine particle dispersed film electrically connected to the second wiring on the first substrate; and
an electroconductive shielding layer formed between the second wiring and the fine particle dispersed film for shielding the fine particle dispersed film from the second wiring.

2. The image display apparatus according to claim 1, wherein
the shielding layer contains at least indium oxide.

3. The image display apparatus according to claim 1, wherein
the shielding layer contains at least antimony oxide.

4. The image display apparatus according to claim 1, wherein
the shielding layer contains at least nickel.

5. The image display apparatus according to claim 1, wherein
the shielding layer has a thickness at least of 1 micro meter.

6. The image display apparatus according to claim 1, wherein
the shielding layer covers at least 80 percent or more of a surface of the second wiring at a side opposite to the second substrate.

7. The image display apparatus according to claim 1, wherein
the fine particle dispersed film is an anti electrostatic film.

8. The image display apparatus according to claim 1, wherein
the fine particle dispersed film is formed from tin oxide doped with antimony.
